(19) United States
(12) Patent Application Publication
(10) Pub. No.: US 2020/0143444 A1
(43) Pub. Date: May 7, 2020

(54) SYSTEM AND METHOD FOR CALCULATING MULTIDIMENSIONAL VALUE SHARING PURCHASE APPLICATION SPECIFIC TO AGRONOMIC CARE PRODUCTS FOR PROFESSIONAL TURF AND ORNAMENTAL MANAGERS

(71) Applicant: Bayer CropScience LP, Research Triangle Park, NC (US)

(72) Inventors: David Maurice WELLS, Raleigh, NC (US); Peter Glen FARNO, Raleigh, NC (US); Mark CLODFELTER, Cary, NC (US); Caitlin NEWERRY, Morristown, NJ (US); Denis G. BRUSNIKIN, New York, NY (US); Max Norman CUDA, New York, NY (US); Sunia HO, Cos Cob, CT (US)

(21) Appl. No.: 16/264,528

(22) Filed: Jan. 31, 2019

Related U.S. Application Data
(60) Provisional application No. 62/756,969, filed on Nov. 7, 2018.

(51) Int. Cl. G06Q 30/06; G06Q 30/02; G06Q 50/02

(52) U.S. Cl. CPC G06Q 30/0621; G06Q 30/0631; G06Q 30/0234; G06Q 50/02; G06Q 30/0222; G06Q 30/0635; G06Q 30/0212

(57) ABSTRACT

The present disclosure relates generally to methods for creating a product package for a user using that take into account both static and dynamic loyalty criteria. The present invention is particularly adapted to utilization by sectors such as the agricultural industry where real time updates along a supply chain would be beneficial to suppliers and distributors.

### CROSS REFERENCE TO RELATED APPLICATION

This application claims the benefit of U.S. Provisional Application Ser. No. 62/756,969, filed Nov. 7, 2018, the contents of which are herein incorporated by reference in their entirety.

### FIELD

The present disclosure relates generally to the selection of desired agronomic products, calculation of transaction costs or rebates, and creation of unique rewards programs based on predetermined criteria programmed into a customizable order application specific to professional turf and ornamental managers including, but not limited to golf course superintendents, lawn care and landscape maintenance companies, sports turf managers, nursery and ornamental managers, and sod farmers.

### BACKGROUND

Turfgrass and ornamental plant management professionals (e.g., golf courses, lawn & landscape maintenance companies, sports turf managers, sod farmers) require a significant amount of time and resources to perform their daily functions. A key time-consuming requirement for these managers is agronomic planning which includes agronomic purchase plans designed to optimize financial leverage of seller sales programs of rebates and payment terms.

Turfgrass and other ornamental plants are professionally managed in multiple ways to provide functional and aesthetic benefits. Accordingly, turfgrass is a highly sought-after premium, and generally expensive, product. Various pests, such as weed, insect and fungal pests, can pose costly threats to the professional turf and ornamental manager, especially premium or exclusive golf courses, sports fields, residences or commercial properties known for their aesthetics. In fact, the median annual maintenance cost to golf courses is in excess of 1.2 million dollars (see, for example, clubbenchmarking.com/blog/golf-course-maintenance-how-much-should-you-spend). Therefore, there is an ongoing need for efficient and automated means of planning and purchasing agronomic products for maintaining turfgrass and other ornamental plants to efficiently procure such products.

Moreover, an agronomic product manufacturer or supplier would benefit from an automated method for providing ordering resources in that the manufacturer or supplier would enjoy reduced costs via removing a PAK assembly and management, simplifying administration, reducing marketing material and working capital while driving top-line sales.

“PAK” as used herein means a physical agronomic product selection or selections generated or delivered to a consumer according to existing methods. The agronomic industry has come to refer to physical bundles of agronomic products as PAKs, “cubes”, “pallets” and other such terms, which may be used interchangeably. PAKs can take the form of, for example, shrink-wrapped bundles of agronomic products optionally on wooden pallets. (See FIG. 1, which depicts existing processes for delivering PAKs.)

For more than 10 years, professional Turfgrass and Ornamental Managers have enjoyed discounts and rebates from agronomic product manufacturers and suppliers largely in 4th quarter of the calendar year. They have experienced growing dissatisfaction with the lack of flexibility for product selection that meets their agronomic needs. Dissatisfaction come from a lack of ability to maximize potential rebates with inflexible product selection, quantities and other limiting factors that may be inconsistent with their agronomic plans.

### SUMMARY

In view of the foregoing background, example implementations of the present disclosure are directed to a new way for providers of agronomic products to streamline the management of access, product selection flexibility and value capture of group orders of agronomic products.

Benefits to the end user include, for example, (a) greater purchase flexibility, (b) simplifying product selection, (c) enrollment in loyalty and/or rewards programs, which are optionally customized to the end user based on variable inputs such as identity, location, atmospheric and/or other agronomic conditions, (d) calculation of transaction rebates with variable outcome directives (e.g. maximizing savings, profit, or satisfying other agronomic-specific conditions), and (e) improved efficiencies in supply chain, inventory and logistics management, and other agronomic administrative processes.

In one embodiment, the algorithm works behind scenes preferably in a circular loop, until a user finalizes a product package and “checks out”.

Benefits to the product provider include, for example, (a) influencing end user product selection to favor the provider's brands or other variable outcome, (b) defining optimal product stewardship (including timing & application requirements), (c) maintaining market relevance, enhancing leadership in the professional turf and ornamental agronomic product category, (d) becoming a trusted advisor by including curated or branded products, (e) providing the customer flexibility to override product selection so the tool can be used with turf manager agronomic planning tools, (f) improving efficiencies in supply chain, inventory management, and other processes, and (g) allowing greater incentive for the suppliers preferred brand offers.

The present disclosure thus includes, without limitation, the following example implementations.

The primary objective of the invention is to provide a computer-implemented method for professional turf and ornamental managers, the method comprising receiving from a mobile device data pertaining to a turf or ornamental manager demographics, identity, location, agronomic conditions, prior purchase history, loyalty preferences and other details associated therewith. Further, uploading the data to a cloud computing system comprised of geospatial servers, database servers, application servers and file servers.

Turf managers with existing agronomic plans can take the output of such agronomic plans to be the basis for ordering. Said output, if available, can be used in conjunction with a unique customizable order application. Further, the data uploaded by the portable device, as well as the data feeds from public, private, and/or government agencies are used as input into a web application, where an end-user can view the resultant vPAK comprising agronomic products selected by the unique customizable order application, any transaction rebates calculated by the unique customizable order application, and/or unique rewards or loyalty programs created or suggested by the unique customizable order application. “vPAK” as used herein means an agronomic product selection or selections produced by the system and methods of the present invention, which optionally include(s) one or more transactional rebates and/or loyalty- or reward-based programs for enrollment.

“Output of an agronomic plan”, as used herein, means any information obtainable from an agronomic plan, including, for example, manually keyed in input to a digitized spreadsheet, a downloadable file, and any mechanism for a starting point for creating a potential product package for a location or locations to be managed according to the agronomic plan.

Further, in the same implementation of the invention, the web application, receiving input as described above, may alert the end-user of the completion status and other metrics regarding the status of agronomic purchases and agronomic care advice based on said purchases. Features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

In a further aspect, there is provided a method for creating a product package for a user using both static and dynamic loyalty criteria, said method comprising:
populating a platform with at least one product to purchase to create an initial product package;
prompting said user to modify said initial product package by suggesting additional products to purchase or modification of said initial package based on one or more of:
   a) a proposed solution to a problem identified as being present by said user,
   b) an additional saving on price by adding additional products or modifying at least one product;
   c) a purchase by said user previously, and/or
   d) a purchase by a third party in a vicinity in geographic proximity to said user;
wherein said dynamic loyalty data is updated in real time and made available across multiple tiers in distribution chain such that responses to said a)-d) populate said dynamic loyalty criteria.

In a yet further embodiment, there is provided a method for providing a suggested product package for purchase by a user, said product package optionally being useful in the agricultural industry, the method comprising:
loading digital data and information, for a location, said data and information comprising one or more of purchase history, demographic information, names and/or types of products desired to purchase, and volume required;
generating a list comprising one or more recommended products or services, available transactional rebates, or reward- or loyalty-based programs, wherein the generation of said list optionally includes criterion comprising one or more of the following:
   (i) a user response to a prompt based on solving a problem the user has identified,
   (ii) pricing based on volume,
   (iii) user history, and/or
   (iv) prior purchase by a third party located in a vicinity of said location, to thereby create a personalized and optimized order protocol for said user; and
providing one or more of a means of purchasing one or more products, a prompt for redeeming an available transactional rebate, or enrolling in a reward- or loyalty-based program, and finalizing a product package, wherein said method permits a purchaser to obtain requirements for a predetermined period of time for said location

### BRIEF DESCRIPTION OF THE DRAWINGS

Having thus described the disclosure in general terms, reference will now be made to the accompanying drawings, which are not necessarily drawn to scale, and wherein:

FIG. 1 depicts the improved efficiency in the flow of PAK orders and deliveries, according to example implementations of the present disclosure.

FIGS. 2A and 2B are illustrations of the sitemap of the vPAK platform, according to example implementations of the present disclosure, wherein the user (e.g., a golf course superintendent or sports turfgrass manager) is logged in (FIG. 2A) or anonymous, i.e., not logged in (FIG. 2B).

FIGS. 3A-3F depict embodiments of a user landing pages and login modals.

FIGS. 4A-4E depict embodiments of a user dashboard page, purchase agreement list panels, and purchase agreement detail page.

FIGS. 5A-5C depict embodiments of a purchase agreement detail page 204 as embodied on a computer or tablet.

FIGS. 6A-6C depict embodiments of the system, according to an example implementation of the present disclosure as embodied on a mobile device.

FIGS. 7A and 7B are illustrations of menus and notification systems according to an embodiment of the present invention.

FIGS. 8A-8I are embodiments of a user interface for creating new purchase orders.

FIGS. 9A, 9B, 10A, 10B, 11A, and 11B describe logic flow diagrams according to one embodiment of the present invention.

FIG. 12 is a logic flow chart showing a circular algorithm according to one embodiment of the present invention.

FIGS. 13A and 13B illustrate the current distribution channel model (FIG. 13A) and the distribution channel model of the present invention (FIG. 13B).

### DETAILED DESCRIPTION OF A PREFERRED EMBODIMENT

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. As used herein, for example, the singular forms “a,” “an,” “the” and the like include plural referents unless the context clearly dictates otherwise. The terms “data,” “information,” “content” and similar terms may be used interchangeably, according to some example implementations of the present invention, to refer to data capable of being transmitted, received, operated on, and/or stored. Also, for example, reference may be made herein to quantitative measures, values, relationships or the like. Unless otherwise stated, any one or more if not all of these may be absolute or approximate to account for acceptable variations that may occur, such as those due to engineering tolerances or the like. Like reference numerals refer to like elements throughout.

“Turfgrass” as used herein means any turfgrass or other grass commonly used for its aesthetic, environmental, economic, playability and comfort value, such as, for example, use in golf course development and maintenance, residential lawns, commercial properties, sports turf fields, etc. As used herein, the terms “turfgrass”, “grass”, and “ornamental grass” are interchangeable.

“Ornamental” care as used herein refers to the maintenance of trees, shrubs, and ornamental plantings in landscapes around residences, commercial buildings, schools & parks, golf courses and other locations that would be managed by professionals. It can also include ornamental plants, trees and shrubs grown in containers or field grown in a nursery or greenhouse setting for the purpose of installing or replacing on maintained properties or resale.

The method of the present invention can either take the output of the professional turf and ornamental manager's agronomic plans, supplier-selected product combinations for common agronomic problems, the turf manager's order history, or available product selection the supplier has deemed to make available to use as an input for a unique customizable order application for an end user or for a representative of the manufacturer authorized to resell such agronomic products. In an aspect, the unique customizable order application selects desired products, calculates transaction rebates, and creates unique rewards (e.g., rebate or loyalty) programs based on predetermined criteria programmed into the algorithm of the customizable order application to generate a vPAK.

“Unique customizable order application” or “customizable order application” as used herein means an application employed according to the method of the present invention, which may use the output of a turf manager's agronomic plan, supplier-selected product combinations for common agronomic problems, the turf manager's order history, or available product selection the supplier has deemed to make available to use as an input to select products, calculate transaction rebates, and create unique rewards programs for an end user in the form of a vPAK.

“Static data” as used herein means data that is unchanging or so rarely changed that it can optionally be stored remotely.

“Dynamic data” as used herein means data that is periodically updated, meaning it changes asynchronously over time as new information is added or changed, which may optionally be added or changed in real time. Dynamic data is data that is not static. Dynamic data may be updated at any time, optionally with periods of inactivity in between updates. Because dynamic data is reused or changed frequently, it generally requires online storage.

In an aspect, static data comprises product use guidelines, contact information, location details (e.g., golf course details such as size or topography), and segment.

In an aspect, dynamic data comprises purchase history, demographic data, or recommendations based on a general agronomic condition or conditions common to turf managers (e.g., control of problematic weeds or diseases common to the turfgrass manager).

“End user details” mean areas of the course to be treated (specific to golf courses), turf composition, soil composition, segments such as fairways, greens, tees and roughs (golf courses), and acres (or other units of measure) of treatable area, an end user's history, and additional existing data including available irrigation, and/or zoning data.

As used herein, the term “product” can refer to a physical item and/or a service or intangible item that could be purchased by a user.

While the present invention is described herein for the agricultural industry, the concepts are equally applicable to use by other industry sectors which have similar needs or structures. For example, it would be envisioned that the present method would work for pest control, maintenance and/or cleaning, food industry, pharmaceutical industry, educational facilities, or any sector where preplanning and/or pre-purchase of goods and/or services for a use or location would potentially be advantageous.

In an aspect, an end user's history includes details regarding priority weeds to be controlled, turfgrass diseases to be prevented or treated, and pest concerns, as well as any identified affected treatable areas (e.g., in acres or other unit of measure), and any preferred product solutions of the end user.

“Agronomic solution” or “agronomic solution transfer” means a recommendation for certain agronomic products either based on an output from the turfgrass manager's agronomic plans or a prompt which is used as an input for the customizable order application. An end user may utilize the customizable order application to select desired agronomic products, calculate transaction rebates, and participate in rewards and/or loyalty programs.

In an aspect, the customizable order application may be embodied in a computer-based platform, in a mobile device application, and/or in a tablet device application.

“Computer-implemented method” as used herein means a method of the present invention as implemented on a computer, on a mobile device, on a tablet device, or on any other electronic internet-enabled device. Thus, “computer-implemented method” is not intended to be limiting.

“DSR” as used herein refers to a Distributor Sales Representative.

In accordance with the present invention, there is provided a system and method which can be used to take requirements for a certain period of time for a location and/or locations and optimize the delivery, nature of product selected and pricing based on volume, user history, other incentives to create a unique and optimized order protocol for each customer or user. The protocol has been termed vPAK.

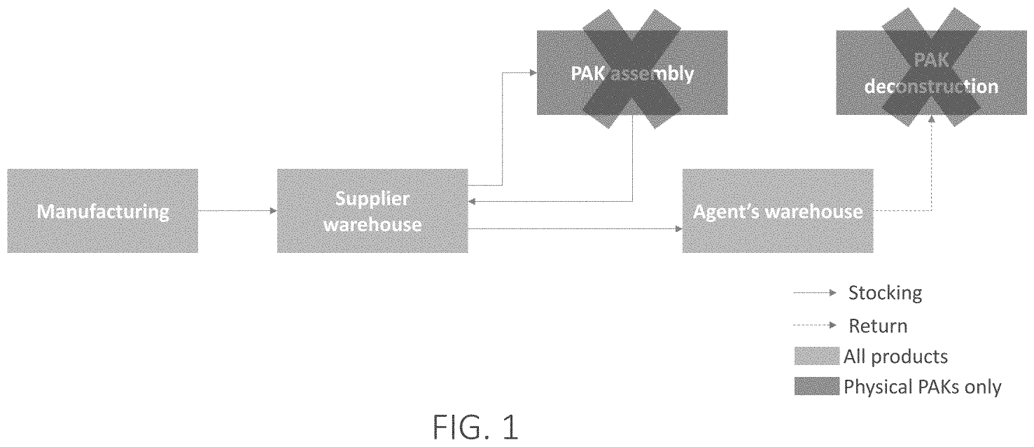

An aspect of the present invention is described by FIG. 1, which depicts the improved efficiency in the flow of PAK orders and deliveries, according to example implementations of the present disclosure; namely, PAK assembly and PAK deconstruction steps may be removed from the supply chain product flow, reducing logistics costs. The present invention further can optimize use of warehousing and movement of goods through the supply chain from supplier to end user. It is envisioned that the present invention would be useful for any agriculture supplier within the supply chain to coordinate obtaining and delivery of goods according to the generated vPAK in such a way to maximize its own costs and time constraints while also allowing for downstream users and customers to also take advantage of incentive programs for making early decisions based on historical use and various programs of bundling supplies to obtain volume type discounts.

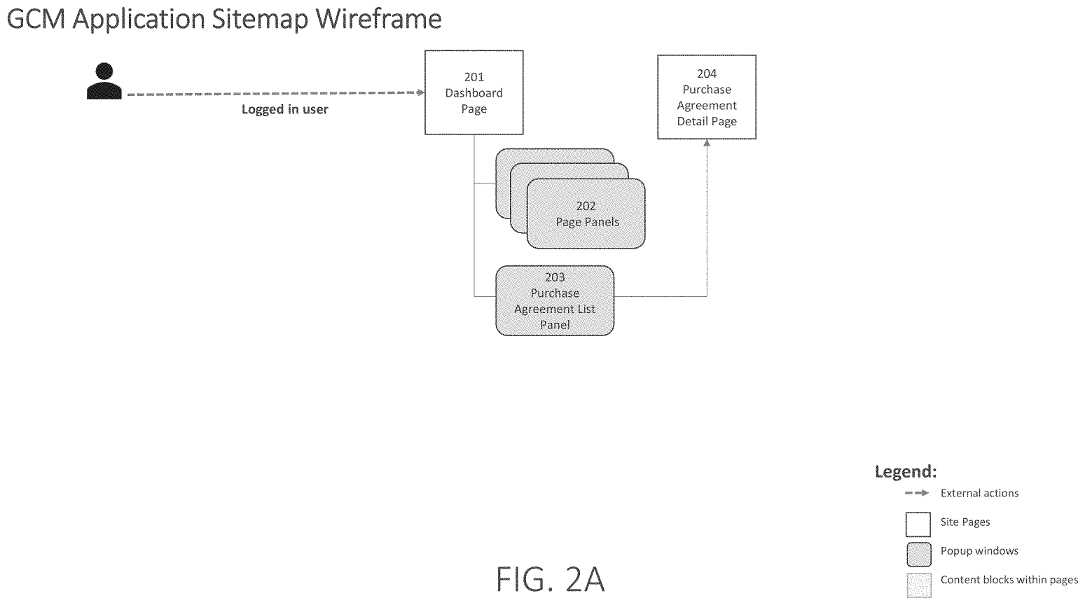

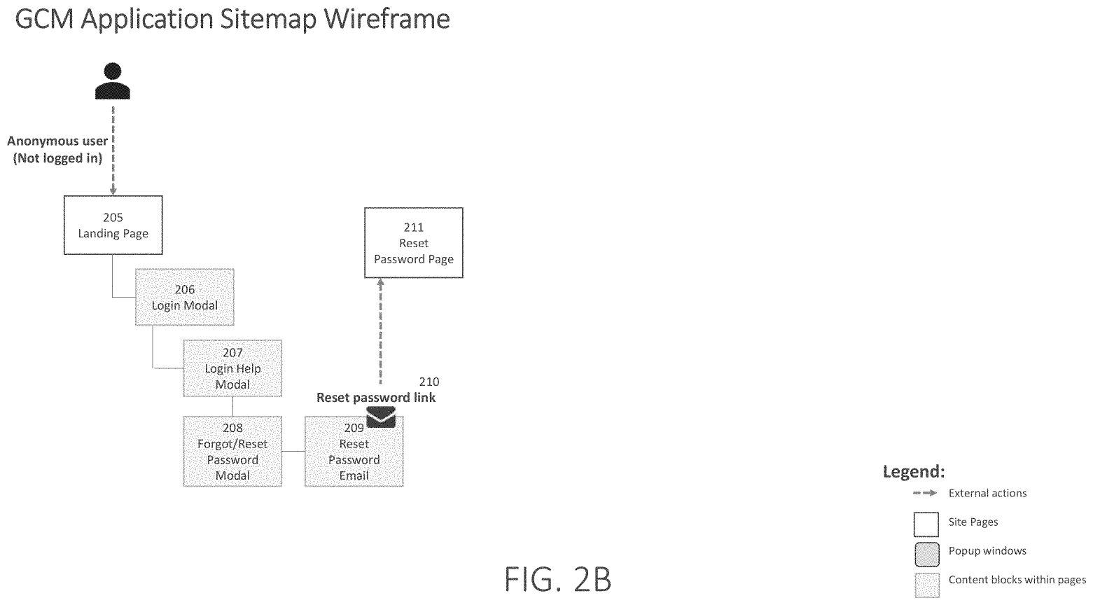

It is contemplated that determining which agronomic goods a particular user will need for a given time and location can be done in any feasible way. For example, the decisions can be completely manually entered into the program or could be automated using any possible mechanism. FIGS. 2A and 2B are illustrations of the sitemap of the vPAK platform, according to example implementations of the present disclosure, wherein the user (e.g., a golf course superintendent or sports turfgrass manager) is logged in (FIG. 2A) or anonymous, i.e., not logged in (FIG. 2B). Wherein the user is logged in, the user is brought first to a dashboard page 201 from which the user may optionally navigate to one or more page panels 202 before navigating to a purchase agreement list panel 203 and ultimately a purchase agreement detail page 204. Wherein the user is anonymous, i.e., not logged in, the user is brought first to a landing page 205 for anonymous users which contains or further navigates to a login modal 206, which contains or further navigates to a login help modal 207, which contains or further navigates to a forgot/reset password modal 208 which the anonymous user may utilize to create, retrieve, reset or otherwise establish a password for logging in. Through the forgot/reset password modal 208, the user may request an automated reset password email 209, which contains a reset password link 210, which directs the user to a reset password page 211 at which the user may create, retrieve, reset or otherwise establish a password for logging in, after which point the user may proceed as a logged in user according to FIG. 2A.

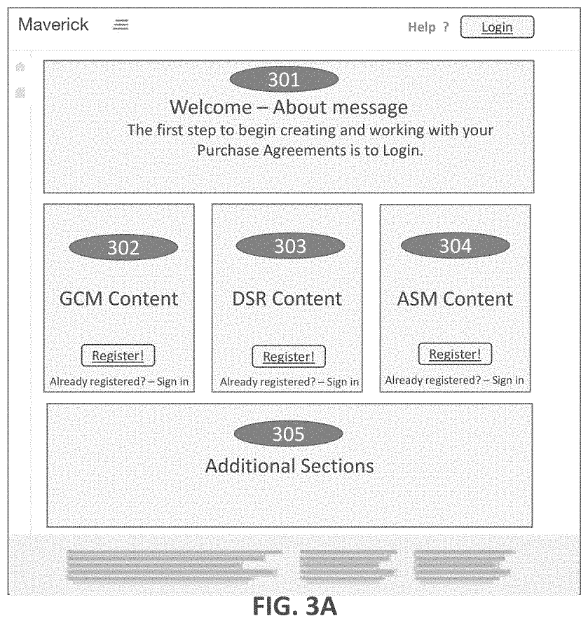

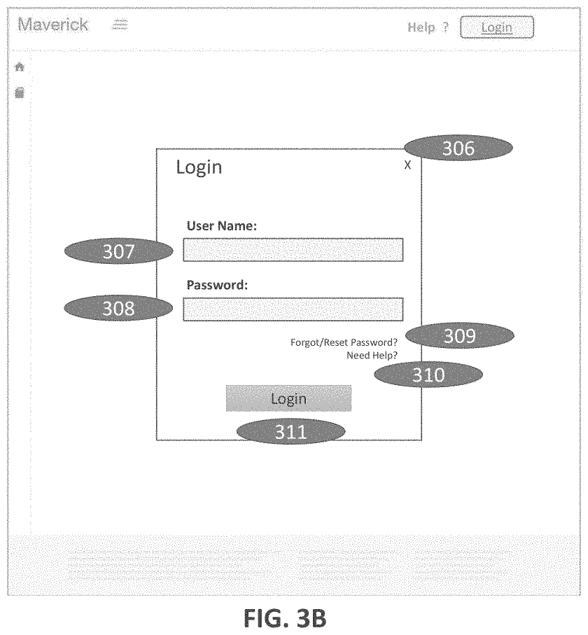

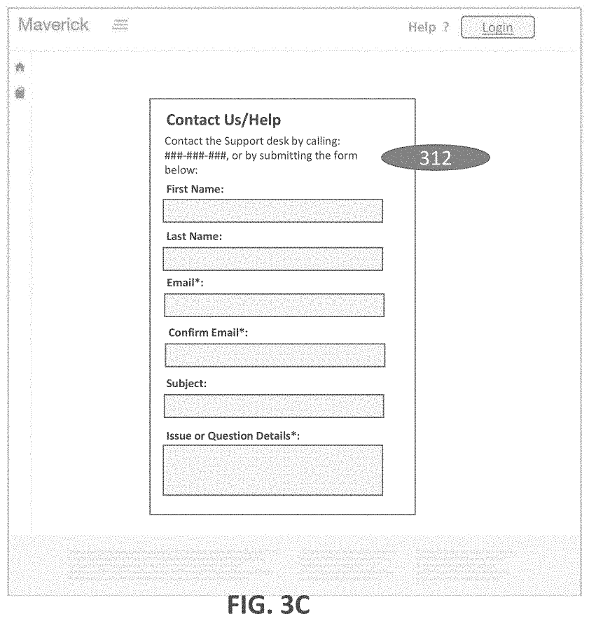

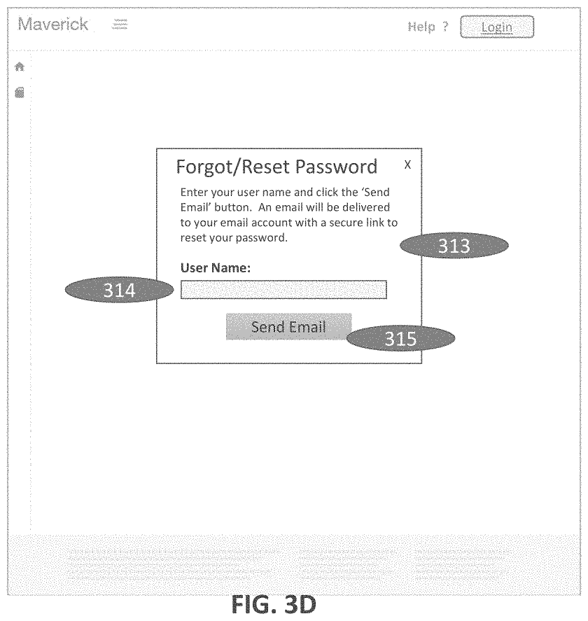

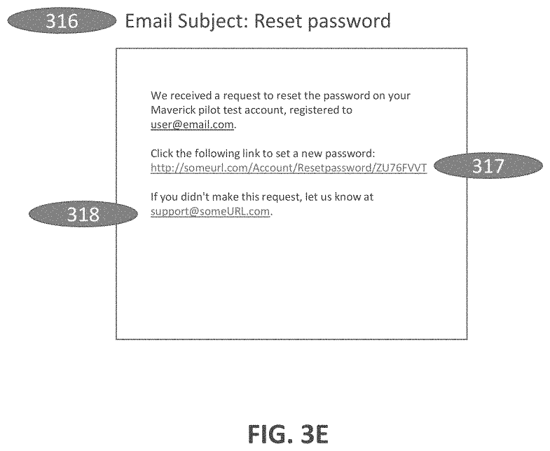

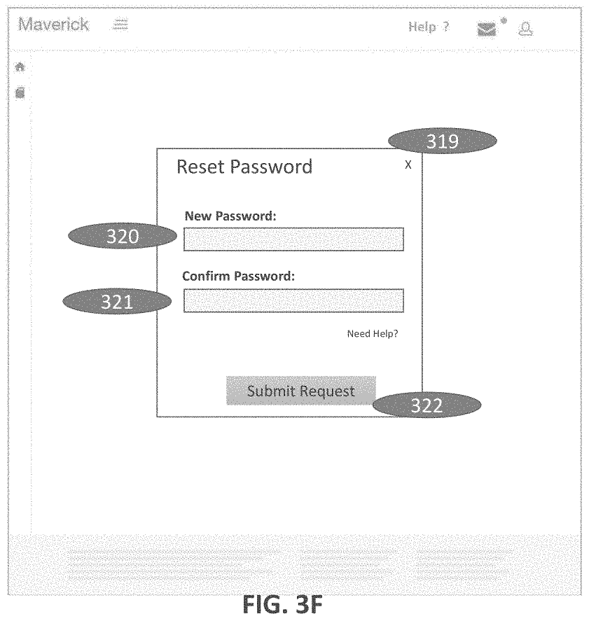

FIG. 3A depicts one embodiment of the anonymous user landing page 205, which may be accessed on a computer, tablet, or mobile device. Said landing page 205 may comprise a welcome or about section 301 which greets the user and/or provides instructions or useful information to the user. The landing page 205 further comprises at least one content sections 302, and optionally 303 and/or 304, which direct the user to a login modal 206. Said landing page 205 may further comprise additional sections 305, such as frequently asked questions (FAQs).

FIG. 3B depicts one embodiment of the login modal 206, which may be accessed on a computer, tablet, or mobile device. Said login modal 206 may be embodied in a separate webpage or in a pop-up window 306 which overlays any public-facing page and which contains a heading and a close modal button. Said login modal 206 contains a user name input field 307, a password input field 308, a “forgot/reset password?” button 309, a “need help?” button 310, and a login button 311. Said “need help?” button triggers the login help modal 207. Said “forgot/reset password?” button 309 triggers forgot/reset password modal 208.

FIG. 3C depicts one embodiment of the login help modal 207, which may be accessed on a computer, tablet, or mobile device. Said login help modal 207 may be embodied in a separate webpage or in a pop-up window 312 which overlays any public-facing page and which contains a heading and a close login help modal button.

FIG. 3D depicts one embodiment of the forgot/reset password modal 208, which may be accessed on a computer, tablet, or mobile device. Said forgot/reset password modal 208 may be embodied in a separate webpage or in a pop-up window 313 which overlays any public-facing page and which contains a heading and a close login help modal button. Said forgot/reset password modal 208 comprises a user name input field 314 in which the user inputs his or her user name, and a send email button 315 which will trigger an automated email to be sent to the email address associated with the user name entered into the user name input field 314.

FIG. 3E depicts one embodiment of the reset password email 209 which may be accessed on a computer, tablet, or mobile device. Said reset password email 209 comprises at least an email subject line 316, instructions and a link for resetting the user's password 317 (corresponding to 210 of FIG. 2B) and a link for requesting password reset help 318.

FIG. 3F depicts one embodiment of the reset password page 211 which may be accessed on a computer, tablet, or mobile device. Said forgot/reset password page 211 may be embodied in a separate webpage or in a pop-up window 319 which overlays any public-facing page and which contains a heading and a close reset password page button. Said forgot/reset password page 211 contains a new password input field 320, a confirm password input field 321, and a submit request button 322.

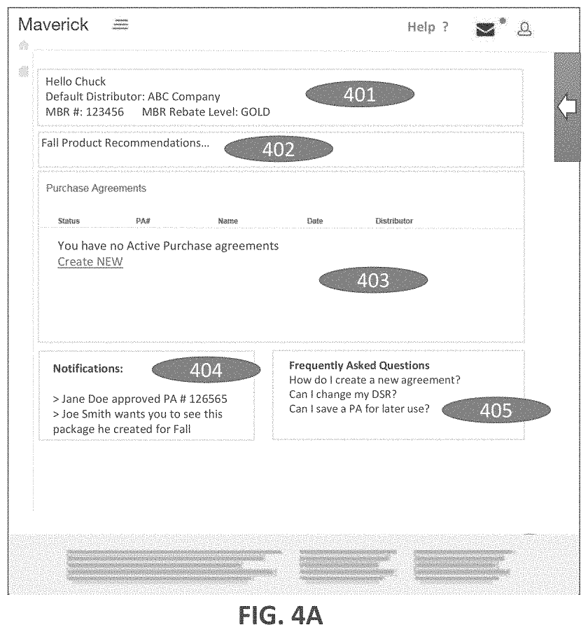

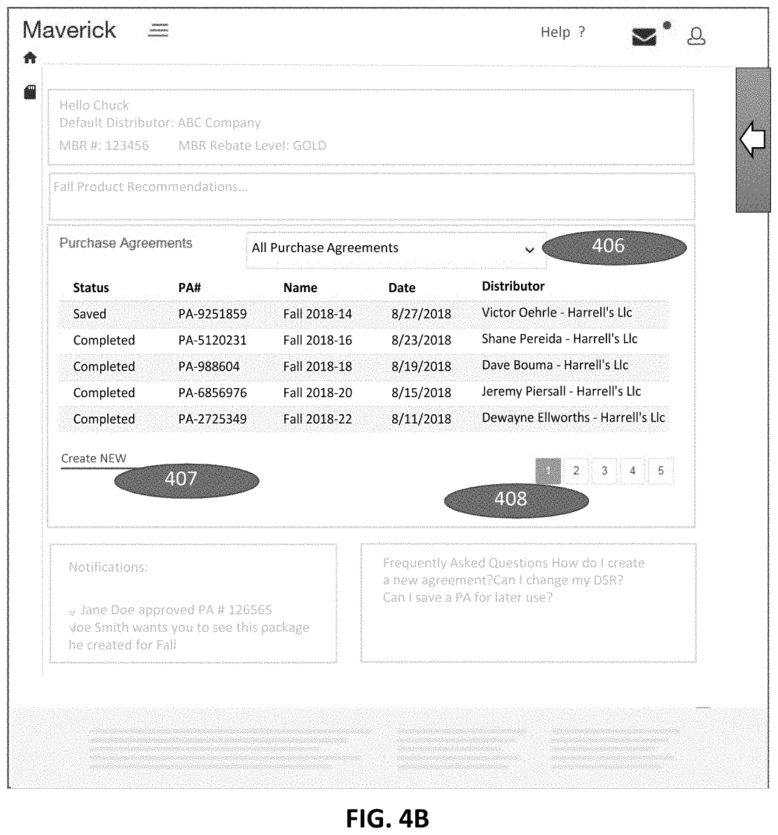

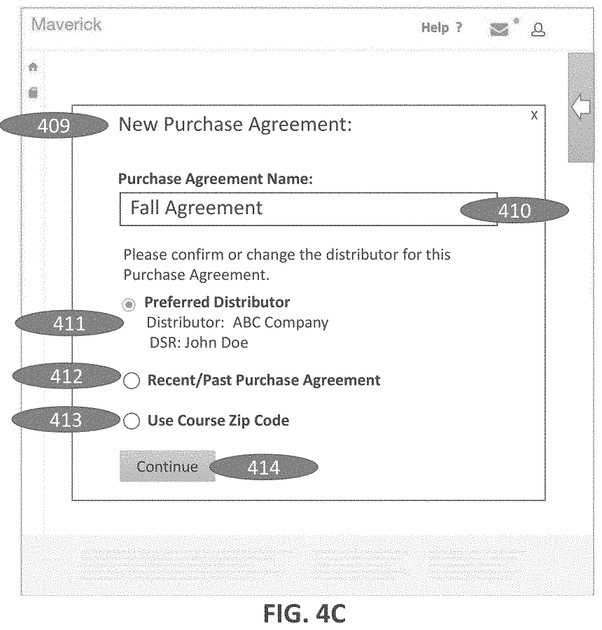

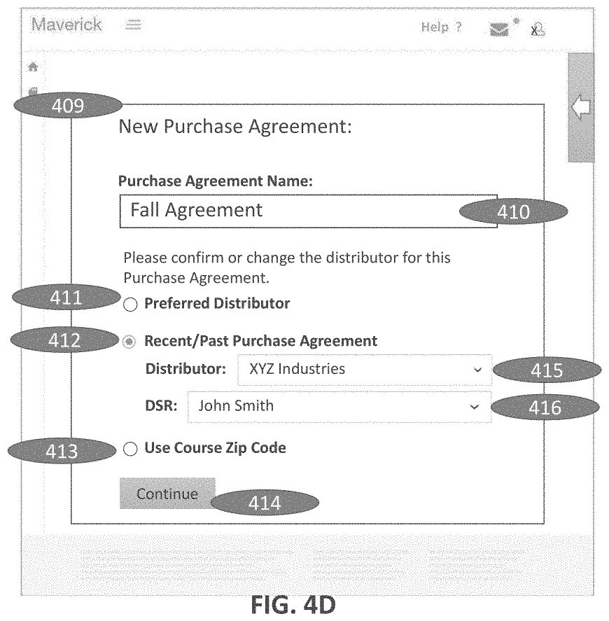

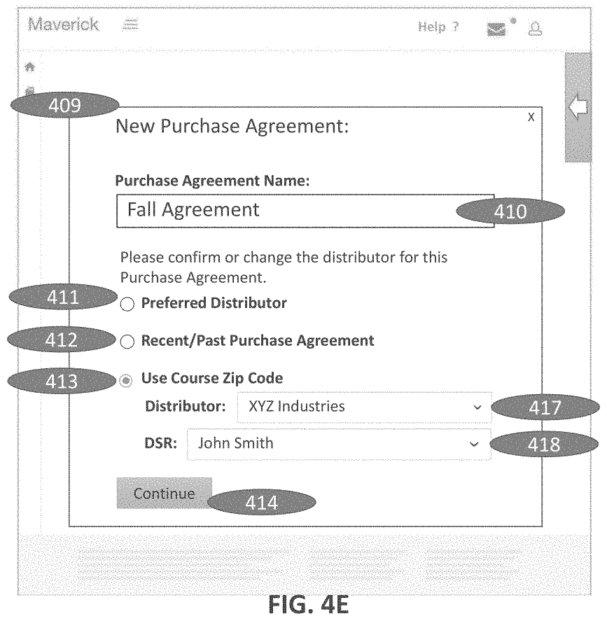

FIG. 4A depicts one embodiment of the user dashboard page 201, which may be accessed on a computer, tablet, or mobile device. Said dashboard page 201 comprises a welcome section 401 which displays or otherwise summarizes the user's identifying information, rebate or loyalty information, default distributor information, and/or other details of the user's profile or account. Said dashboard page 201 further comprises an announcement section 402 which displays announcements, promotions, and/or advertisements from distributors. Said dashboard page 201 further comprises a purchase agreements section 403 which contains one or more purchase agreement list panels 203 which display active purchase agreements and/or a message or instructions for the user to create a new purchase agreement. Said dashboard page 201 further comprises a notifications panel 404 and a frequently asked questions (FAQs) panel 405. Upon the first time the user accesses the user dashboard page 201, the user will not have any existing purchasing agreements displayed in the purchase agreements section 403 and thus a link will be provided to the user to create a new purchase agreement.

FIG. 4B depicts an embodiment of the purchase agreement list panel 203, which may be accessed on a computer, tablet, or mobile device. FIG. 4B depicts, in particular, a scenario in which the user has saved or completed purchase agreements. Said purchase agreement list panel 203 comprises a drop-down 406 from which the user may select or filter purchase agreements based on status, date, or other criteria. Said purchase agreement list panel 203 comprises a “create new” link 407 which allows the user to create a new purchase agreement. If a larger number of purchase agreements exists than fits within the purchase agreement list panel 203, pagination controls 408 will be displayed.

FIG. 4C depicts an embodiment of the purchase agreement detail page 204, which may be accessed on a computer, tablet, or mobile device. Said purchase agreement detail page 204 may be embodied in a separate webpage or in a pop-up window 409 which overlays the purchase agreement list panel 203 or other page, and which contains a heading and a close new purchase agreement page button. Said purchase agreement detail page 204 comprises a purchase agreement name input field 410, options for selecting either a preferred distributor 411, a distributor based on a recent/past purchase agreement 412, or a distributor based on the course (i.e., golf course) zip code 413, and a “continue” button 414 to proceed with creation of a new purchase agreement. In particular, FIG. 4C depicts an embodiment of the purchase agreement detail page 204 in which the preferred distributor option 411 is selected.

FIG. 4D depicts another embodiment of the purchase agreement detail page 204 in which the recent/past purchase agreement distributor option 412 is selected. Said purchase agreement detail page 204 comprises distributor drop-downs 415 and 416 when recent/past purchase agreement distributor option 412 is selected.

FIG. 4E depicts another embodiment of the purchase agreement detail page 204 in which the course zip code distributor option 413 is selected. Said purchase agreement detail page 204 comprises distributor drop-downs 417 and 418 when course zip code distributor option 413 is selected.

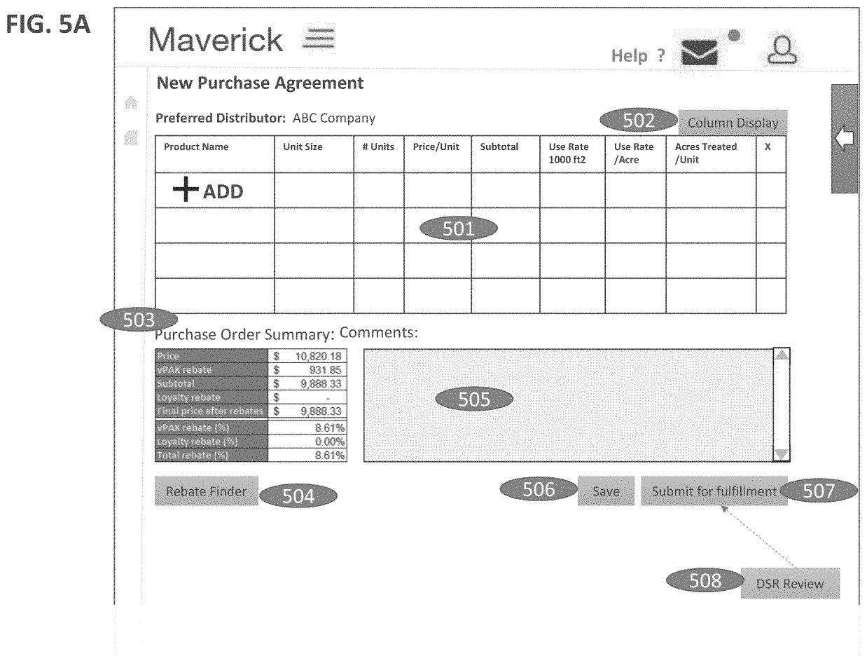

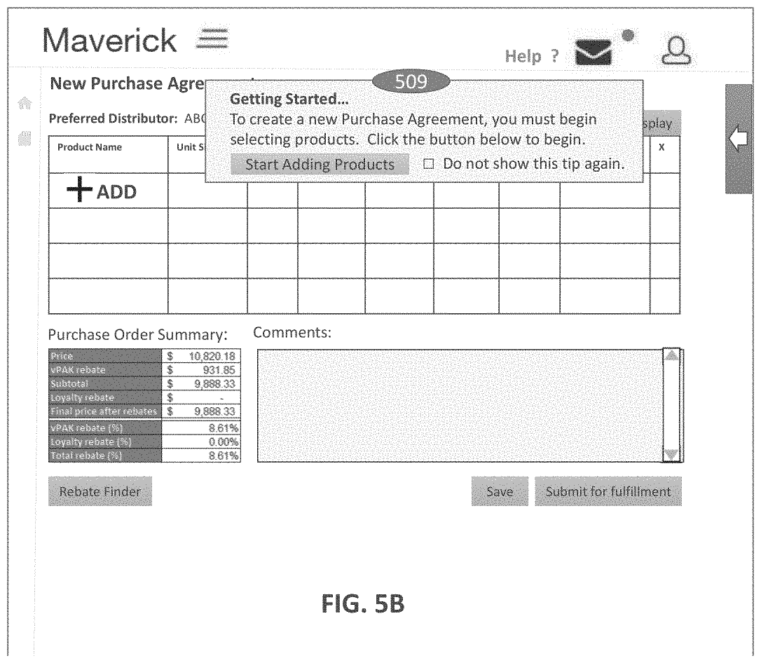

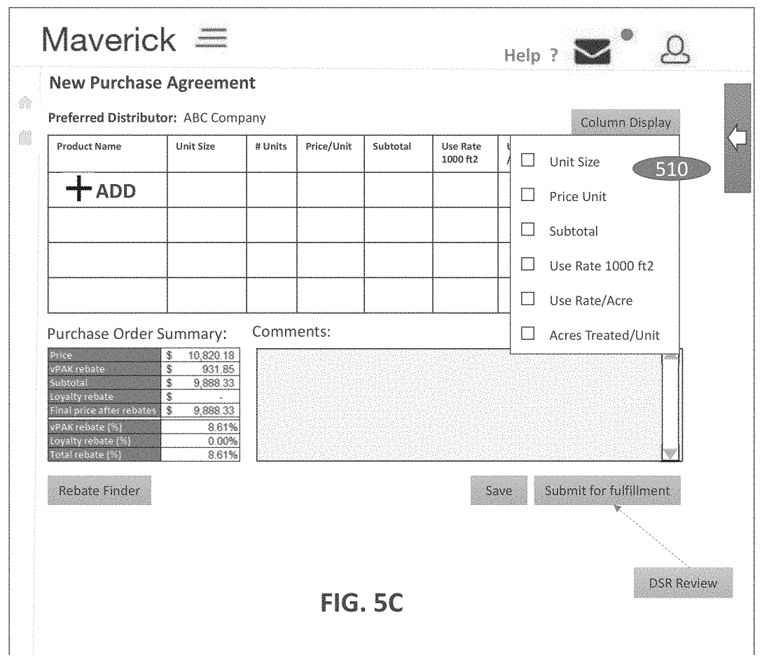

FIGS. 5A-5C depict embodiments of the purchase agreement detail page 204 as embodied on a computer or tablet.

FIG. 5A depicts an embodiment of the purchase agreement detail page 204 as embodied on a computer or tablet wherein said purchase agreement detail page 204 sets forth purchase agreement line items in a table format 501, which is sortable by columns in a drop-down column display menu 502. Said purchase agreement detail page further comprises a purchase order summary table 503, a rebate finder button 504 which allows a user to see any rebate deals for which they qualify based on the selected products added to the purchase agreement as calculated using variable inputs including but not limited to identity, demographic, location, and other agronomic inputs, a comments input field 505, a save button 506 which allows the user to save a purchase agreement without submitting for fulfillment, a “submit for fulfillment” button 507 which submits the purchase agreement for fulfillment by the selected distributor, and a “DSR review” button 508 which allows the user to submit on any purchase agreement in which there has been a price adjustment.

FIG. 5B depicts an embodiment of the purchase agreement detail page 204 as embodied on a computer or tablet wherein the user is greeted by a prompt 509 instructing the user how to create a new purchase agreement.

FIG. 5C depicts an embodiment of the purchase agreement detail page 204 as embodied on a computer or tablet wherein the user may sort or filter products in a drop-down column display 510 which allows the user to display products based on, for example, unit size, price unit, subtotal, use rates, acres treated, and/or other criteria.

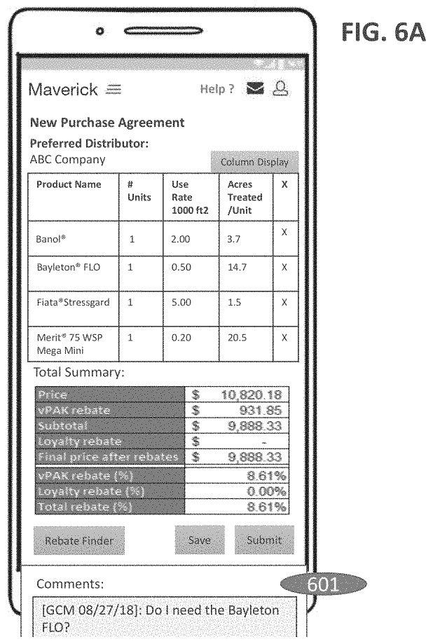

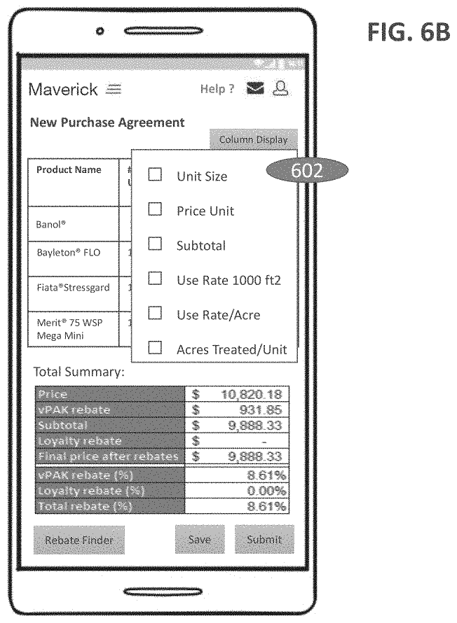

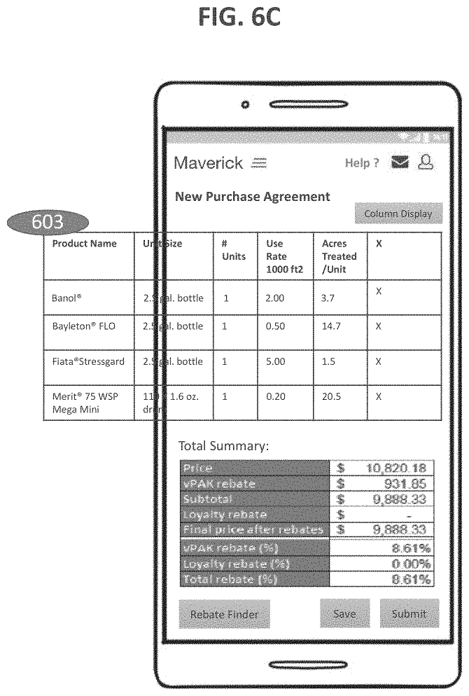

FIGS. 6A-6C depict embodiments of the purchase agreement detail page 204 as embodied on a mobile device. FIG. 6A depicts an embodiment of the purchase agreement detail page 204 as embodied on a mobile device wherein the user and distributor may communicate via a messaging component 601. FIG. 6B depicts an embodiment of the purchase agreement detail page 204 as embodied on a mobile device wherein the user and distributor may filter or sort agronomic products based on one or more criteria from a drop-down 602. FIG. 6C depicts an embodiment of the purchase agreement detail page 204 as embodied on a mobile device featuring a horizontal scroll 603.

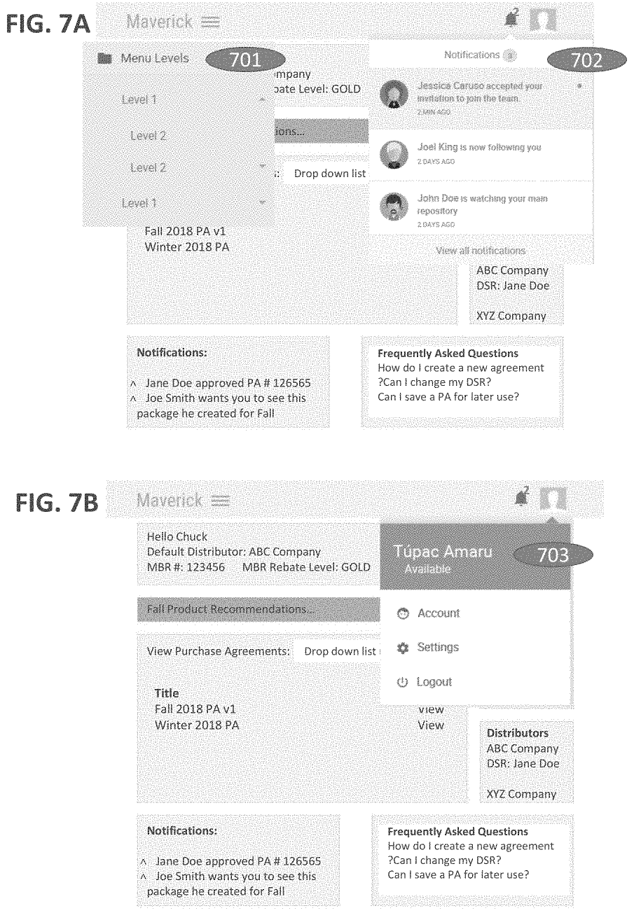

FIGS. 7A and 7B depict embodiments of the user dashboard page 201 which may be accessed on a computer, tablet, or mobile device. Said dashboard page 201 provides notifications for the user's review 701 and menus navigable by the user 702 (FIG. 7A) and profile options 703 for the user's review or modification (FIG. 7B).

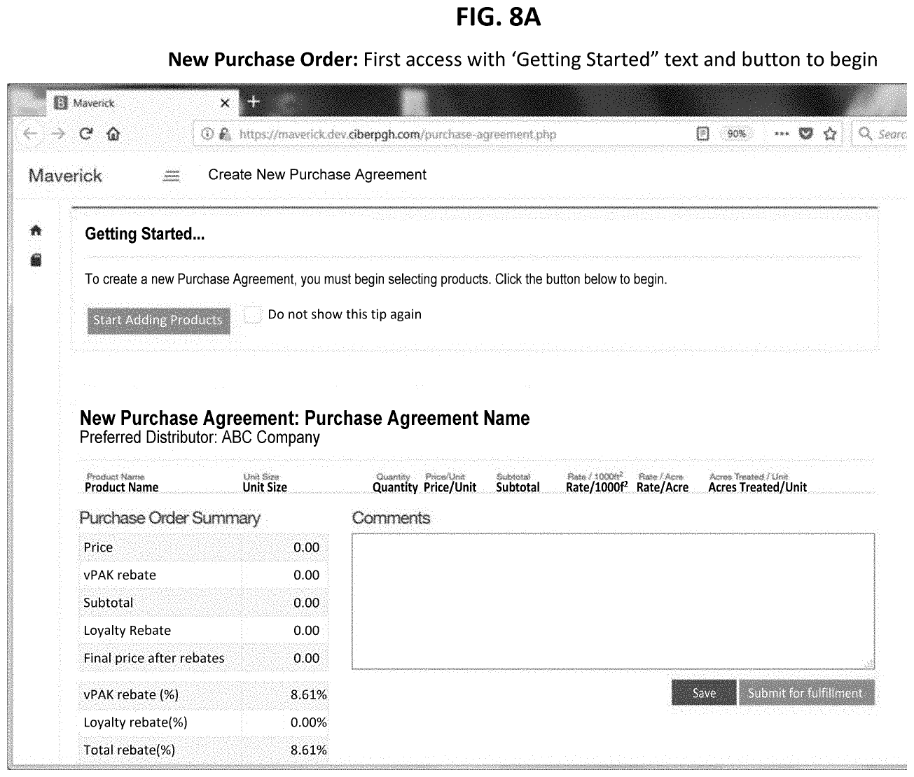

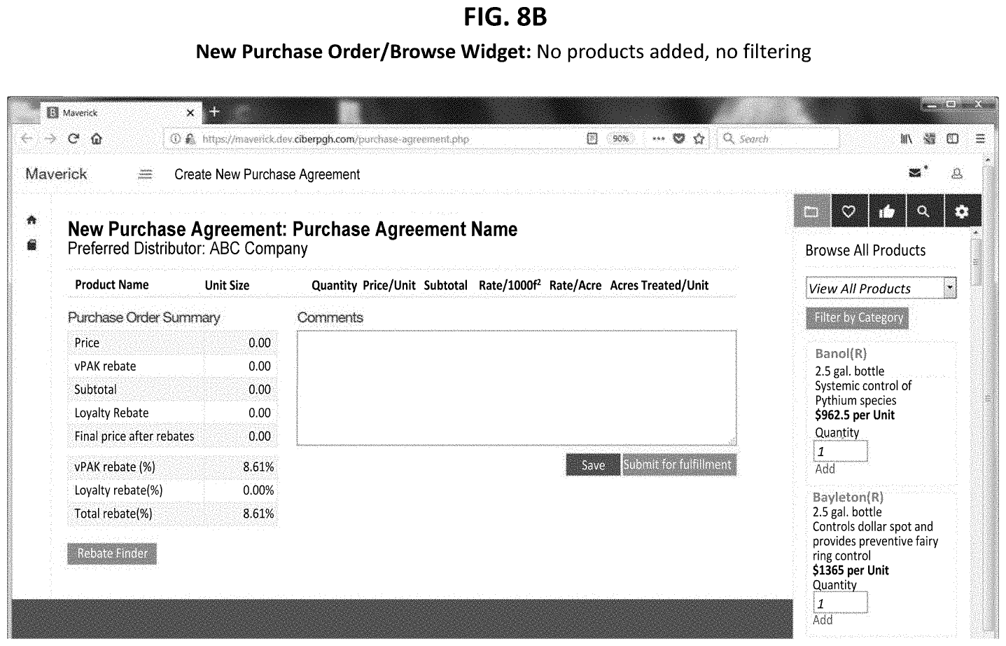

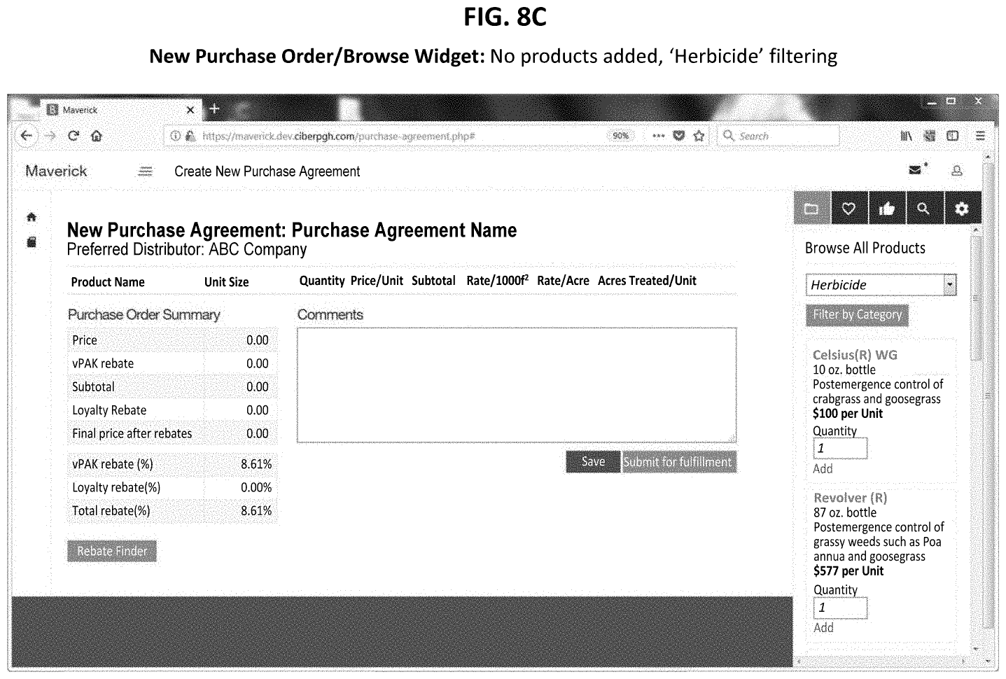

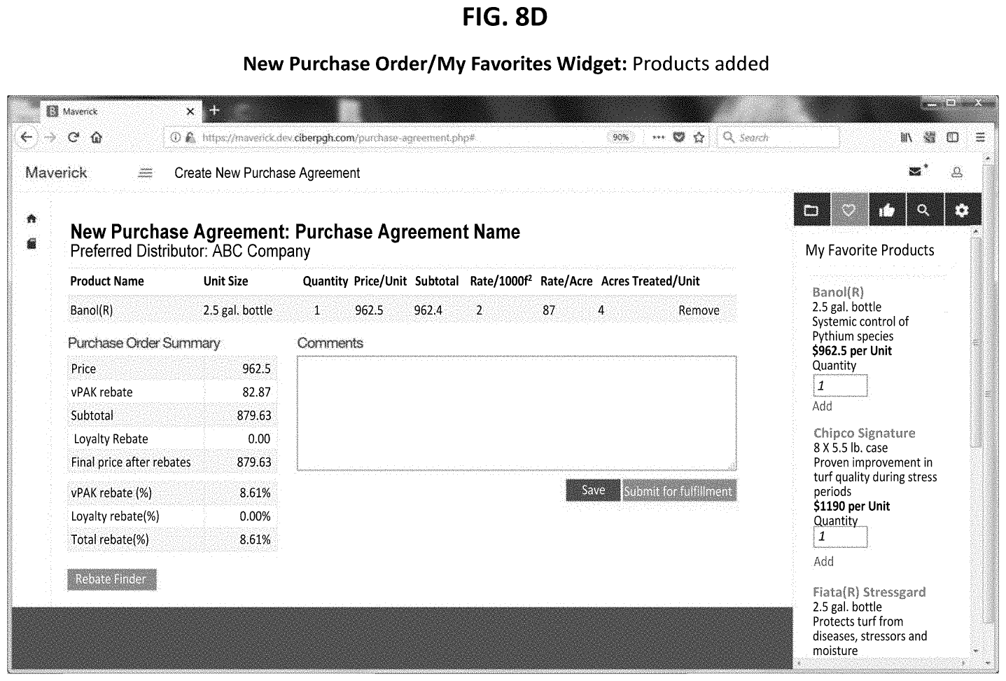

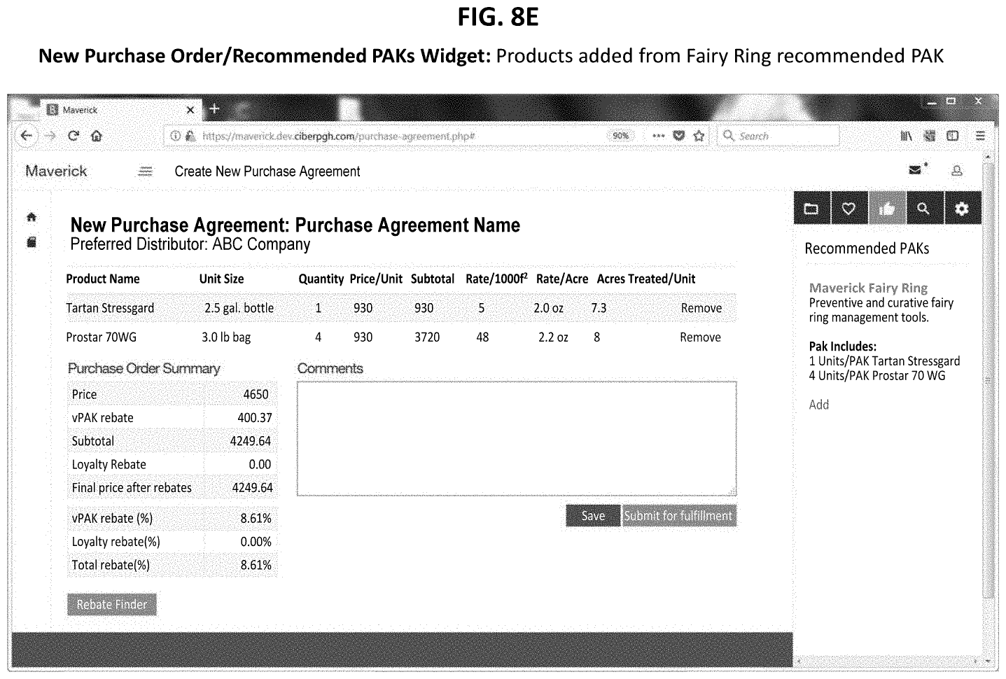

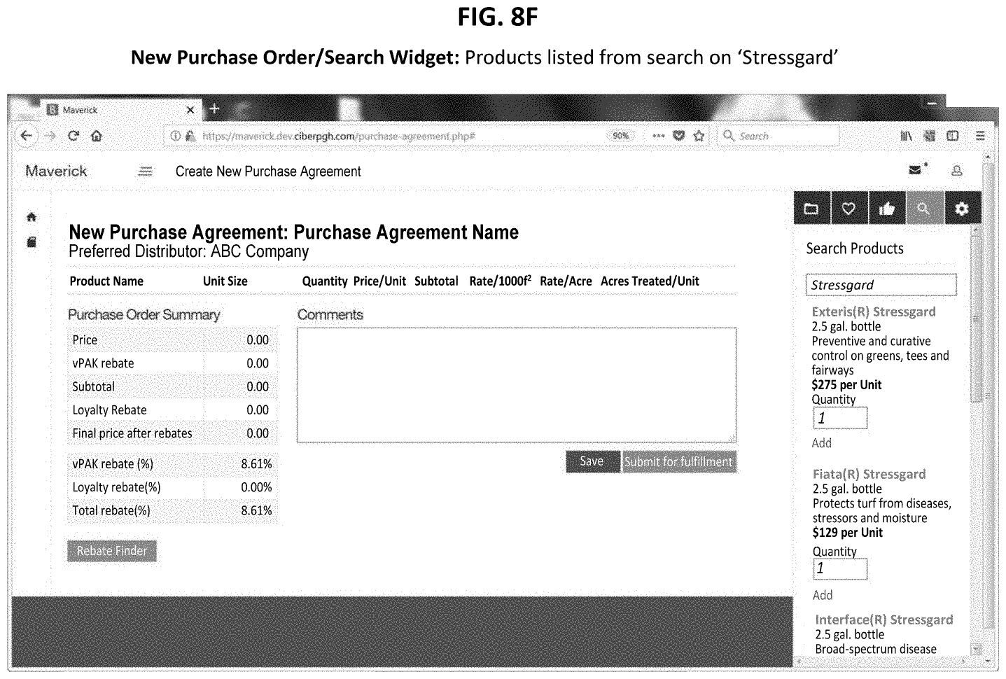

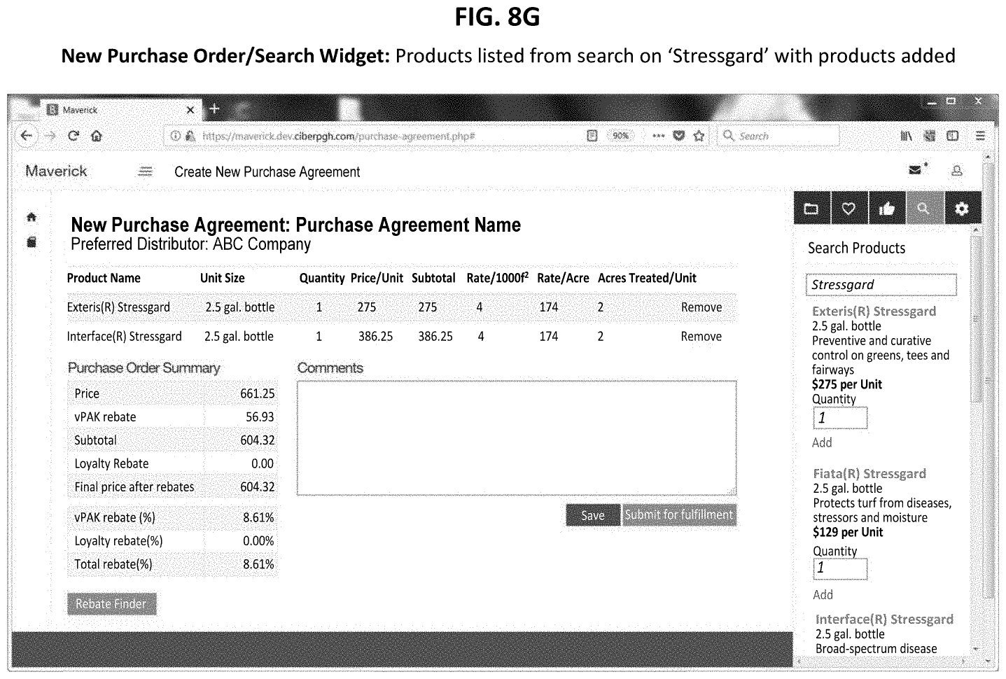

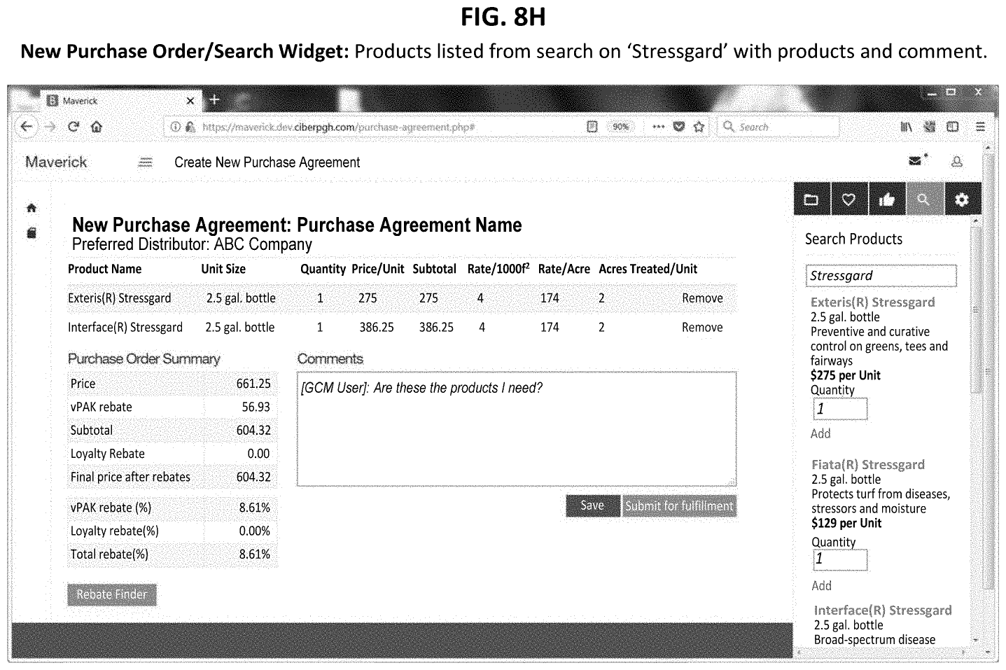

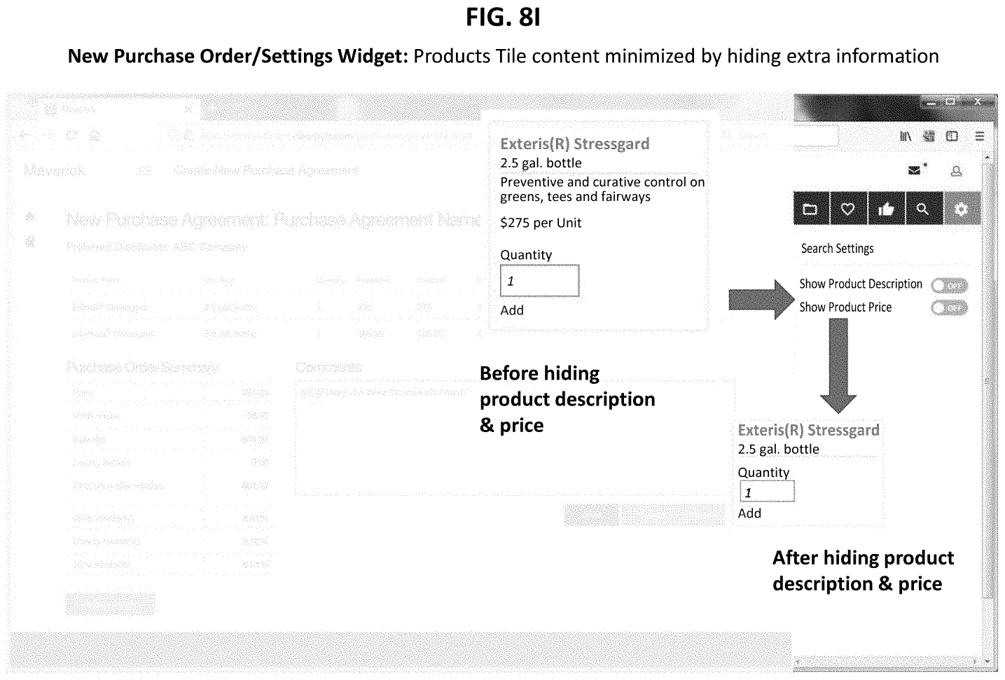

FIGS. 8A-8I depict embodiments of a user interface for creating new purchase orders.

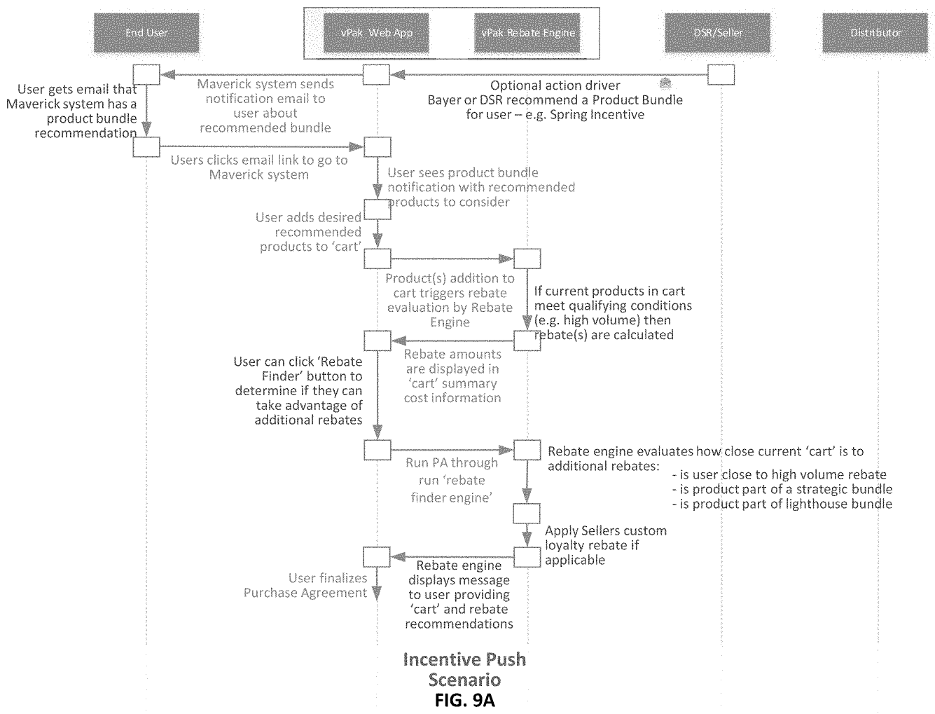

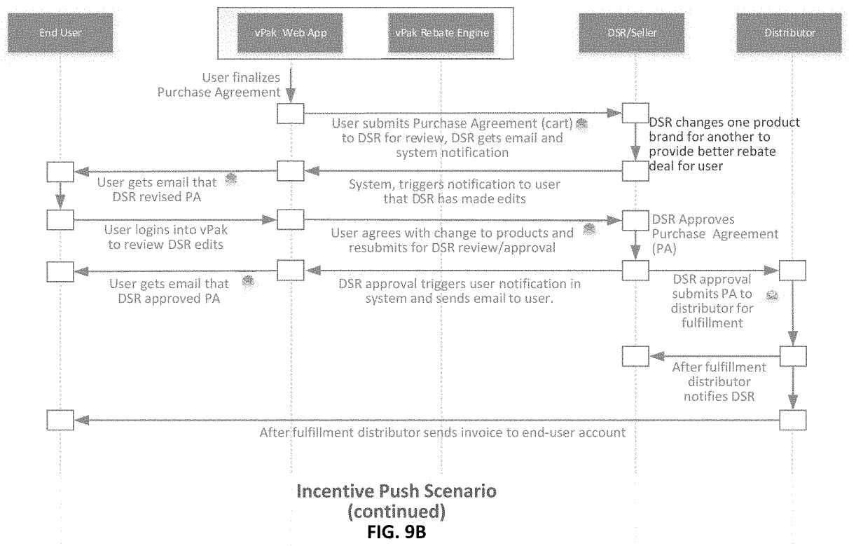

FIGS. 9A and 9B depict a logic flow chart for the method of the present invention, wherein the seller initiates the process and the vPAK tool prompts the user via email to review and select from recommended products. In an “incentive push” scenario, a user is provided with a selection of recommended products, which may be bundled or otherwise grouped together—e.g., a Spring Incentive bundle of agronomic products particularly suited for use in the spring. Upon the user's selection of one or more of the recommended products, the rebate engine evaluates the selected product(s) and calculates any available rebate based on qualifying conditions. The rebate engine further provides prompts to the user, which provide rebate recommendations.

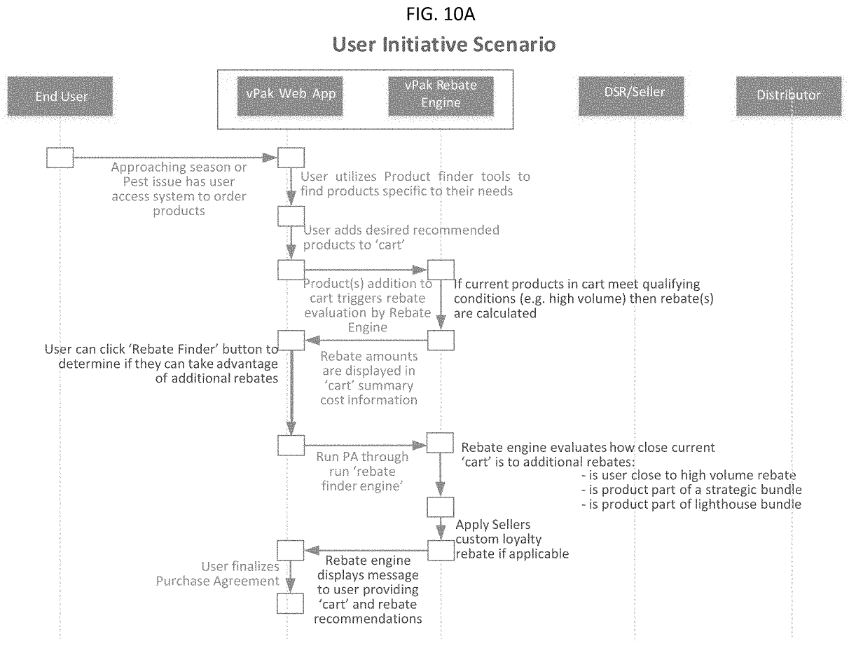

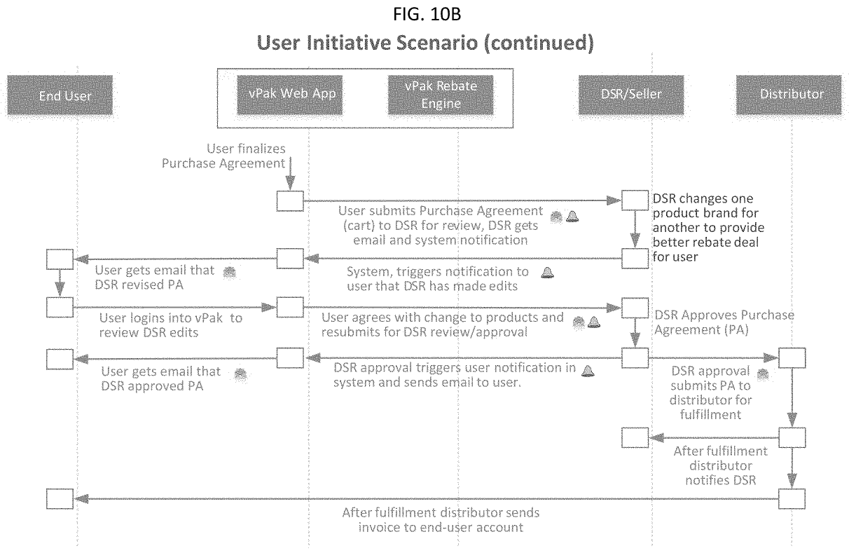

FIGS. 10A and 10B depict a logic flow chart for the method of the present invention, wherein the user initiates the process. In a “user initiated” scenario, the user accesses the vPAK tool to find agronomic products suited to the user's particular needs. Rebates are calculated based on the user's selected agronomic products and are displayed for the user's review prior to finalizing the purchase. The user then can utilize a “rebate finder” which provides the user with any additional rebates for which they can qualify. Ifthe user utilizes the rebate finder, the rebate engine will evaluate how close the user is to qualifying for an additional rebate or rebates and will then instruct the user how to qualify for said additional rebate(s)—e.g., by increasing purchase volume or by selecting particular additional products.

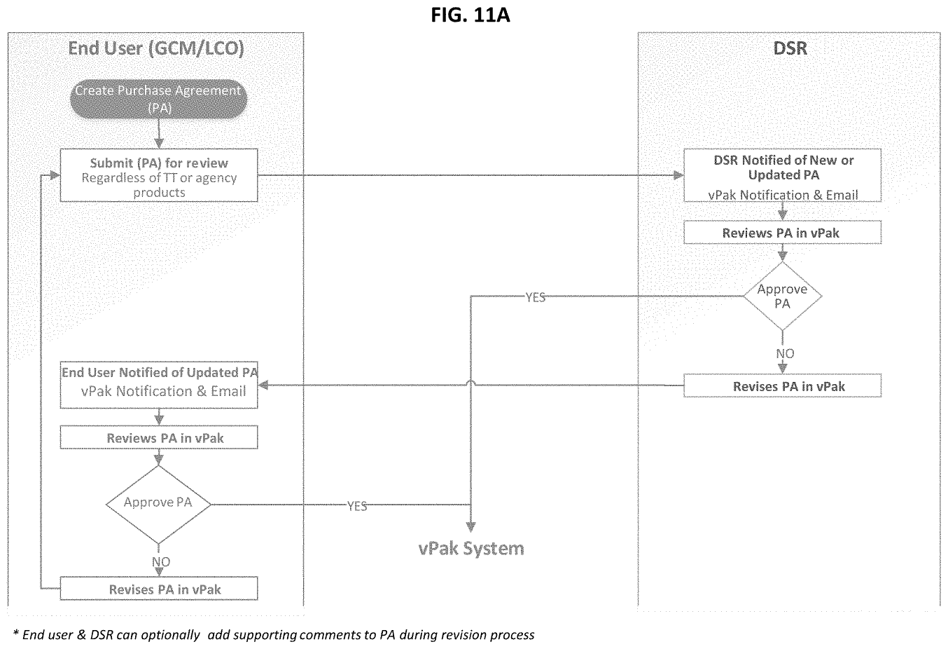

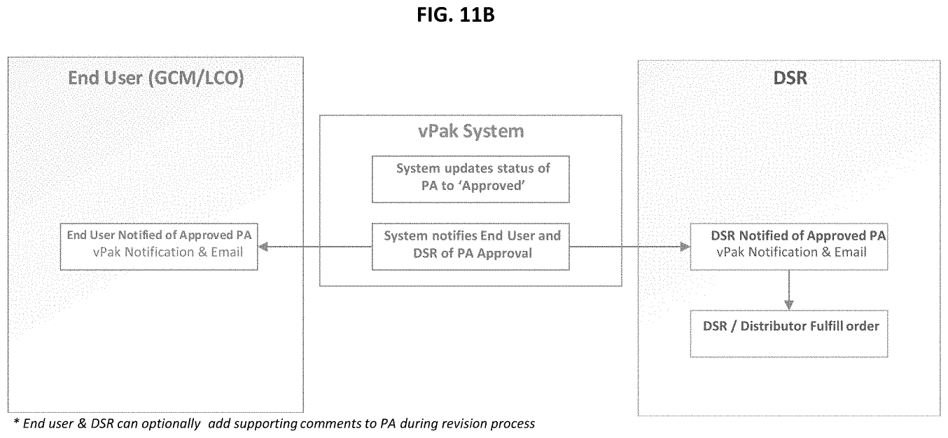

FIGS. 11A and 11B depict a flow chart illustrating the communication between a user/purchaser (e.g., a golf course manager or “GCM”), a DSR, and the vPAK tool. The user submits a purchase agreement for the DSR's approval, which is either approved or revised. Ifthe purchase agreement is revised by the DSR, the user reviews the revised purchase agreement and either approves or further revises the purchase agreement. This process repeats until both the user and DSR have approved the purchase agreement, at which point the vPAK tool updates the status of the purchase agreement to “approved” and notifies both the user and DSR of the status change. The DSR then fulfills the purchase agreement and may optionally update the purchase agreement with, for example, inventory numbers.

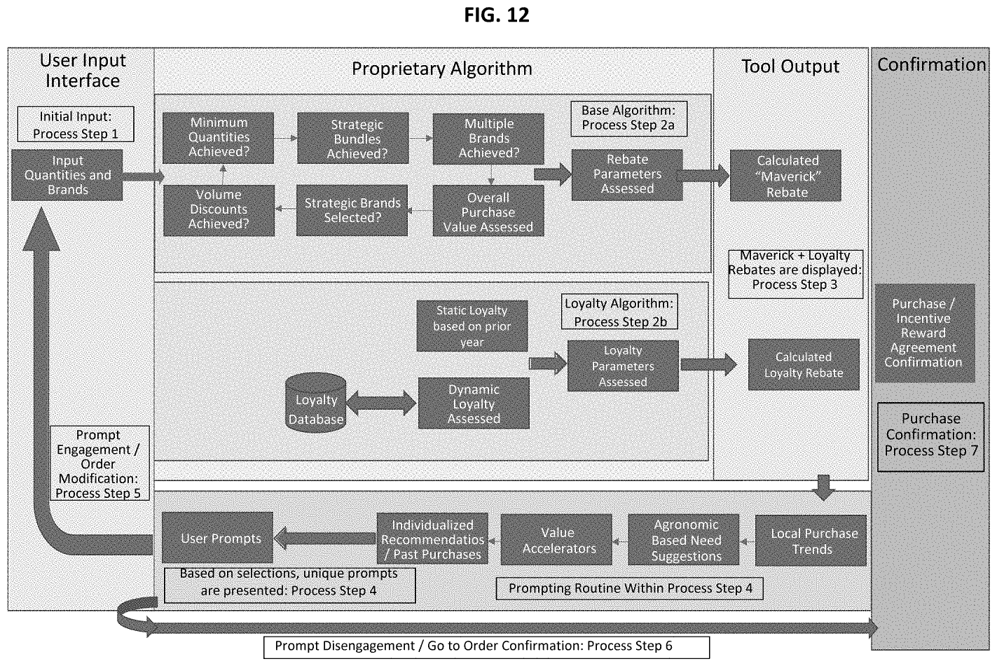

FIG. 12 is circular diagram depicting the logic that is used by the vPAK tool to create the final purchased “cart” by an end user. There are multiple queries that can be utilized and logic behind the algorithm shown in the central section of FIG. 12 will be optionally constantly updating the options and pricing during the selection process and user experience with the vPAK tool.

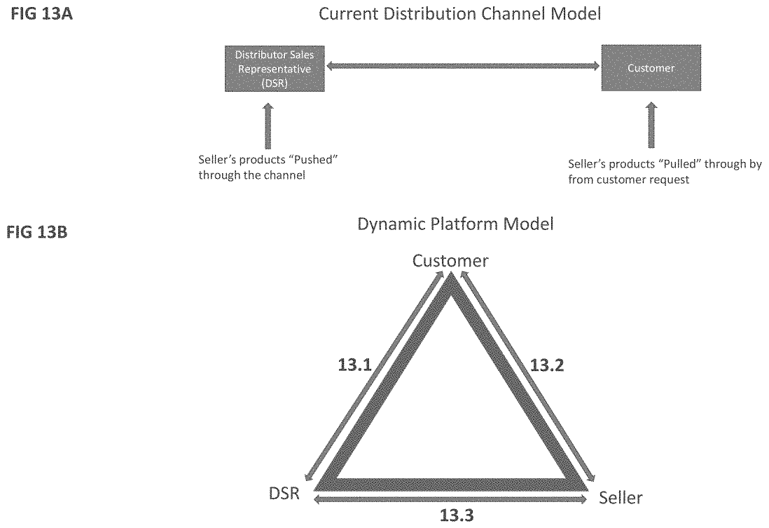

FIG. 13A is a diagram depicting the current distribution channel model whereby a DSR and customer are in communication with one another. In the current distribution channel model, the seller's products are pushed through the channel by the DSR and pulled through the channel by the customer's request.

FIG. 13B is a diagram depicting the distribution channel model employed by the present invention, whereby a DSR, customer and seller are in communication with one another. The DSR and customer utilize the seller's platform to facilitate purchase discussion 13.1. The customer shares proposed purchase intentions directly with the seller and the seller responds (e.g., loyalty rebate, etc.) to provide for a dynamic exchange between the customer and the seller at the time of purchase agreement finalization 13.2. The seller shares platform data with the DSR 13.3, allowing the parties to continuously improve the platform.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

In one embodiment, the envisioned protocol includes the following calculations of the multidimensional features to create the incentive plan or rebate.

For example, in the case of a golf course as a possible customer/end user, the relevant purchaser will have a spreadsheet or other output of products they intend to buy for their site over a specific time frame. In such a case, an end user will prepopulate or load shopping cart. Once items are entered, the application will prompt in optionally one or more of the following four scenarios:

1) The application will propose agronomic prompting/solutions. For example, the user may receive prompts such as “Are you interested in treating broadleaf leaves?” or “Are you in need of treatment for dandelions?” Depending on the responses, brands and usage will be suggested along with savings scenarios.

2) A value-oriented option will be triggered. For example, if the user increases the quantity of a selected product from x to y quantity, the rebate for which the user qualifies will increase, or if the user purchases a particular product, the rebate for which the user qualifies will increase if the user purchases a particular second, third, fourth, or further additional particular product or products.

3) What are users in proximity to current user buying? For example, a prompt will show products purchased by users within, for example, 60 miles of the current user, and what products were selected.

4) The application will prompt user to add products that have been purchased before.

By using one or more of identity, demographics, location, and/or other agronomic plan inputs, unique and/or multiple loyalty/rebate offerings are presented to the user after being calculated in the context of a predefined outcome directive (e.g. maximizing profit or savings, or other agronomic condition such as replicating prior purchases, treating particular conditions known to be present and/or providing similar products that were purchased by similarly situated user in same geographic area and for similar usage).

As described, for example, in FIG. 12, there is provided a sample workflow of optionally 7 steps that may be taken by a method of the present invention. This sample workflow of a suitable algorithm is described as follows:

### Step 1: Initial Input

Turfgrass Manager enters agronomic product brands and quantities. Products selected can come from sources such as:

Past experience/knowledge of the brands

Turfgrass Manager's agronomic planning assessment tool/reference (if it exists)

Brand awareness or otherwise unprompted product/brand interest

Anticipated needs for a desired time horizon, and budgetary constraints/financial management

Otherwise random product/brand selection based on agronomic product type (e.g. insecticide, herbicide, fungicide), or brand name;

TABLE 1
Example Turfgrass Manager Input*

| Brand | Unit of Measure | Quantity |
|---|---|---|
| Fungicide Brand X | 2.5 gallon jug | 10 |
| Fungicide Brand Y | 5 lb. bottle | 20 |
| Herbicide Brand A | 1 gallon bottle | 5 |

### Step 2: Algorithm Calculations. Algorithm Calculations Consist of 2 Component Parts

### Step 2A: Base Algorithm Calculation

Overall rebate parameters (min. & max. values) are set as overarching reward limits
Product brands and quantities selected in Step 1, are assessed based on criteria such as:
Are established algorithm minimum quantities achieved?
Do brand quantities trigger a “volume discount”?
Have algorithm-established “strategic bundles” been achieved?

Have “strategic brands” been selected?

Based on the overall number of brands selected, is the algorithm's “multiple brand” incentive achieved?

Does the overall purchase commitment achieve an overall dollar value incentives?

Based on the comparison of the selected product brands and quantities, compared to the algorithm criteria, overall incentives are compared to minimum and maximum incentives at a brand level. Overall incentives are advantageously within an established min. and max. incentive parameters that are set by the algorithm.

The proposed algorithm optionally has additional flexibility to override incentives, and/or add or remove additional criteria to address business, agronomic or market needs.

### Step 2B: Loyalty Algorithm Calculations

There are 2 elements to the discreet “Loyalty Incentive” within the vPAK algorithm:
   Static Loyalty: Based on the Turfgrass Manager's prior year loyalty, a loyalty value is assigned to the Turfgrass Manager. This value is fixed for a period of time (e.g. calendar year, fiscal year, quarter, etc.). This static value is reassessed at the end of the fixed period
   Dynamic Loyalty: Based on the selected product brands and quantities (Step 1), vPAK algorithm connects with a loyalty database to assess dynamic criteria such as:
      Period-to-date purchase activity
      Changes in purchase activity compared to the prior period
      Simulated “share of wallet” calculations
      Portfolio/strategic brand support

### Step 3: Algorithm Calculations Displayed

Calculations based on input of brands & quantities (Step 1) and

Incentives (Step 2A Base Incentive and Step 2B Loyalty Incentive) are displayed:

TABLE 2
Example Turfgrass Manager Input:

| Brand | Unit of Measure | Quantity |
|---|---|---|
| Fungicide Brand X | 2.5 gallon jug | 10 |
| Fungicide Brand Y | 5 lb. bottle | 20 |
| Herbicide Brand A | 1 gallon bottle | 5 |

TABLE 3
Example Output/Display:

| Total Estimated Purchase | $XXXX |
|---|---|
| Base Incentive (a) | $XXXX |
| Loyalty Incentive (b) | $XXXX |
| Total Incentive (a + b) | $XXXX/X % |

Simultaneous to “Output/Display” (Step 3), “Prompts” are optionally displayed (Step 4).

### Step 4: Prompts

Based on the selected brands & quantities (Step 1) and Incentive Calculations (Step 2A and Step 2B) which are displayed (Step 3), “Prompts” will be displayed unique to the Turfgrass Manager (Step 4).

The prompts displayed are an output of the “prompting routine” which consists of elements such as:

Local Purchase Trends: Turfgrass Managers will be offered recommendations for agronomic products that similar Turfgrass Managers use in their related geography.

Agronomic Based Needs: Simple navigation will allow the Turfgrass Manager to suggest product solutions based on agronomic needs (e.g. “Weed Control” or more specifically “Crabgrass Control”). The suggested agronomic prompts will be intuitive based on the type of Turfgrass Manager (e.g. golf course superintendent, lawn care operator, etc.), geography, and environmental conditions causing conducive conditions for pest, weed and other agronomic conditions relevant to the specific Turfgrass Manager.

Value Accelerators: Based on the algorithm calculations derived from selected brands and quantities, suggestions will be offered to the Turfgrass Manager to accelerate incentives. Examples suggestions such as complimentary agronomic products that enhance algorithm calculations, products that create a “strategic bundle” within the algorithm, suggestions to change product quantities to maximize specific volume incentives, and other algorithm “triggers” not otherwise transparent (e.g. number of overall brands, overall dollar value, inclusion of otherwise unknown strategic brands, etc.).

Individualized Recommendations/Past Purchases: Product brand and quantity selections (Step 1) may or may not be populated by historical purchases of the Turfgrass Manager, although it may be an option. The individualized recommendation prompt could suitably compare the Turfgrass Manager's selected products to historical purchases to makes suggestions the Turfgrass Manager may use on a less frequent basis or be non-strategic brands in algorithm calculations, but have agronomic benefit to the Turfgrass Manager.

Depicted below is a limited visualization of “Prompt Engagement” that would suggest value, agronomic or local solutions for the Turfgrass Manager

TABLE 4
Example Turfgrass Manager Input with Value/Agronomic Prompts:

| | | | “Click” Here | |
|---|---|---|---|---|
| | Unit of | | for Related | Prompt Displayed |
| Brand | Measure | Quantity | Suggestions | Upon “Click” |
| Fungicide | 2.5 gallon | 10 | | Increase to 20 for |
| Brand X | jug | | | max. reward |
| Fungicide | 5 lb. bottle | 20 | | When you buy Product |
| Brand Y | | | | x with this Product, |
| | | | | your overall reward |
| | | | | grows |
| Herbicide | 1 gallon | 5 | | Reduce the risk of |
| Brand A | bottle | | | weed resistance if |
| | | | | you add product A |
| | | | | to this product |

TABLE 5
Exemplary prompt options for algorithm
Prompt Displayed Upon “Click”

Increase to 20 for max. reward
When you buy Product x with this Product, your overall reward grows
Reduce the risk of weed resistance if you add product A to this product

TABLE 6
Sample Agronomic Solution Prompts
Need Help With?

[symbol]

Weed Control (drop down menu product/solution) [symbol]
Insect Control (drop down menu product/solution) [symbol]
Disease Control (drop down menu product/solution)

TABLE 7
Sample Local/Agronomic Prompts
What are Turfgrass Managers in My Area Doing?

[symbol]

Many of your peers are using Product X [symbol]
Increased moisture in your area anticipated, increasing the
likelihood of pest X [symbol]
Regulations are changing in your area. Many of your peers are
moving to product X to address this change.

### Step 5: Prompt Engagement/Order Modification

Based on the “Prompts” displayed via the “Prompt Routine” (Step 4), each prompt “engaged” by the Turfgrass Manager potentially offers the opportunity to modify the original product brands and quantities selected

Should the Turfgrass Manager engage with any prompts that modify the mix of product brands and quantities, the original Step 1 has thus been modified, therefore the algorithm recalculates (Step 2), displays newly revised incentives (Step 3)

Based on these modifications, the prompt process (Step 4) is optionally repeated and/or revised with new prompts based on the modified product and quantity mix.

The process loops until the Turfgrass Manager exits the loop by “Disengaging from Prompts” (Step 6) to move to “Order Confirmation” (Step 7)

### Step 6: Prompt Disengagement

At any point after incentives are displayed (Step 3), the Turfgrass Manager can move to confirm the purchase agreement.

There is no requirement for the Turfgrass Manager to engage with “prompts”

By default, when the Turfgrass Manager moves to “Order Confirmation” (Step 7), he/she has “disengaged” from the intuitive prompts.

### Step 7: Purchase/Incentive Confirmation

Once all products & quantities have been selected the Turfgrass Manager validates with their corresponding distributor representative to validate relevant terms of sale (e.g. price, terms, credit worthiness, delivery, etc.)

Once validated, the purchase agreement is memorialized with a “unique identifier” confirming the commitment for purchase and the corresponding incentive the Turfgrass Manager will receive within specified timelines once the sale is consummated.

In an alternate embodiment, it is possible to provide a system, method and product wherein not only products per se a purchased by a user, but also services can be monetized. One unique area that the vPak brings value is the ability to monetize value-add features that can be used either singly, or together with products purchased. For example, it could be possible for a user to purchase items such as product guarantees, technical service support, and the like and assign a value to each or for a bundle. Such monetized services could be offered within the protocol as additional features to add as part of a volume discount etc. Up to now, such services are commonly offered only as value adds, but no manufacturer has been able to include them as an option that has a monetized value.

In addition, in accordance with an aspect of the present invention, it would be advantageous to provide visibility and ability to immediately accrue for future sales and rebates. Currently it is a common practice to offer early order programs for purchasing products to be used late. In such campaigns rebates for sales are commonly offered. However, because of the delay, such early sales are often recorded and invoiced days or weeks after the fact and reported back to up the supply chain sometimes weeks or even months after the actual transaction date. Similarly, rebates are calculated and paid months after the transaction. Accruals for rebates are based on historical assumptions but with often large sales volumes (ie possibly tens of millions of sales) occurring in early order programs, a small shift in product demand or product mix can have a significant swing in rebate obligations versus rebate accruals. With the vPak, there is provided a way to electronically project what sales are committed to, and what the potential rebate may be. As such the potential benefits are multiple. By providing a mechanism for immediate visibility of pending sales, it is possible to dramatically improve financial forecasting in terms of sales and rebates to precise financial expectations. Furthermore, it is possible to provide accurate accrued funds for future obligations and assess shifts in profitability to upstream suppliers on a real time basis. The presently disclosed method and product can also provide advance notice when a certain product upticks in sales, which can greatly improve supply chain efforts by the manufacturer and the distributor. Up to now, there has not been disclosed any tool available that proactively forecasts anticipated sales and rebates and give insights in supply chain demands far in advance of actual reported transactions.

While the instant description involves use by an agronomic purchaser, it is equally envisioned that the method could be utilized in any other section that includes supply chains and would benefit by having real time information available across the supply chain. While other platforms have been used in the past, the present method and platform provides an update to dynamic loyalty data in real time such that access to that information is available in real time across the supply chain. As such, the most upstream supplier(s) will know what goods and services have been sold by distributors immediately and in real time. This knowledge can assist with planning, warehousing and production line prioritization among other things.

As explained above, the present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the appended claims. Moreover, although the foregoing description and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for providing a suggested product package for purchase by a user, the product package optionally being useful in the agricultural industry, the method comprising:
loading digital data and information, for a location via a web application to a rebate engine, wherein the digital data and information comprises one or more of purchase history, demographic information, names, types of products desired to purchase, and volume required;
retrieving a loyalty data from loyalty databases via the rebate engine;
generating a list comprising one or more recommended products or services, available transactional rebates, or reward- or loyalty-based programs by calculating multidimensional features in view of the digital data and the loyalty data via the rebate engine, wherein the multidimensional features comprise criterion comprising one or more of the following:
(i) a user response to a prompt based on solving a problem the user has identified,
(ii) pricing based on volume,
(iii) a user history, and
(iv) a prior purchase by a third party located in a vicinity of the location, to thereby create a personalized and optimized order protocol for the user;
generating at least a product or a volume suggestion to accelerate incentives;
displaying the list and at least the product or the volume suggestion via the web application; and
providing via the web application one or more of a means of a prompt to adjust the digital data by the user in view of at least the product or the volume suggestion, purchasing one or more products, a prompt for redeeming an available transactional rebate, or enrolling in a reward- or loyalty-based program, and finalizing a product package, wherein the method permits a purchaser to obtain requirements for a predetermined period of time for the location;
wherein the list and at least the product or the volume suggestion are constantly updated with a second list and at least a second product or a second volume suggestion in light of the adjusted digital data by the user via re-generating the second list and at least the second product or the second volume suggestion by re-calculating the multidimensional feature in view of the adjusted digital data and the loyalty data.

2. The method according to claim 1, further comprising: providing a means of modifying the list comprising one or more recommended agronomic products, available transactional rebates, or reward- or loyalty-based programs via the web application.

3.

4.

5.

6.

7.

8.

9.

10.

11.

12.

13. The method according to claim 1, wherein the loyalty databases comprise a static loyalty data and a dynamic loyalty data.
